(19) United States
(12) Patent Application Publication
(10) Pub. No.: US 2004/0070193 A1
(43) Pub. Date: Apr. 15, 2004

(54) Book

(76) Inventors: Oliviero Dolci, Milano (IT); Emanuela Moltani, Milano (IT)

Correspondence Address: KATTEN MUCHIN ZAVIS ROSENMAN, 575 MADISON AVENUE, NEW YORK, NY, 10022-2585, US

(21) Appl. No.: 10/642,999

(22) Filed: Aug. 18, 2003

(30) Foreign Application Priority Data
Oct. 2, 2002 (EP) 02425598.6

(51) Int. Cl. B42D 1/00

(52) U.S. Cl. 281/38

(57) ABSTRACT

The present invention relates to a book (1) comprising a plurality of pages bound together and divided into different sections (2,3,4) adjacent to each other; each of the sections comprises at least one page (2A,3A,4A) of a first type and at least one page (2B,3B,4B) of a second type; all the pages of each section have the same shape; pages of different sections have different shapes; when the book is closed, the combination of the different sections (2,3,4) forms a subject in relief.

### DESCRIPTION

The present invention relates to a book comprising a plurality of pages bound together and divided into different sections adjacent to each other.

As is well-known, books consist of pages which are all identical and enclosed by a cover; the cover may consist, for example, of two sheets of cardboard and the pages of the book are placed between the two sheets of cardboard.

Often the pages of the book are divided into different sections; this division into sections may correspond, for example, but not necessarily, to different subjects dealt with in the book.

Reading a book generally requires a certain amount of intellectual effort and is therefore considered by many persons to be a demanding pastime. Obviously not all the articles in the form of a book have a highly intellectual content (for example a restaurant menu).

In the case of children's books, in order to make the book more attractive, illustrations are used in a systematic manner; moreover, with the same aim in mind, shaped books have become fairly widespread, said books being such that both the cover and all the pages of the book have the same shaped contour.

Still with regard to children, in particular younger children, solutions have been proposed (for example in U.S. Pat. Nos. 5,096,204 and 5,901,983) where articles may be used both as books, when open, and as toys, when closed since in this case they assume the form of three-dimensional objects; in this way the book is made to be more appealing to the child.

In the case of adults' books, sometimes it is attempted to achieve a greater appeal by means of the image reproduced on the cover; it is true, however, that hitherto not much effort has been made to improve the attractiveness in general of book articles intended for adults.

The object of the present invention is that of providing an article in the form of a book which is more appealing than those which are known.

This object is substantially achieved by a book comprising a plurality of pages which are bound together and divided into different sections adjacent to each other and characterized in that each of the sections comprises at least one page of a first type and at least one page of a second type, in that all the pages of each section have the same shape, in that pages of different sections have different shapes and in that, when the book is closed, the combination of the different sections forms a subject in relief.

The subject in relief undoubtedly offers an appeal which benefits the article in the form a book according to the present invention.

Further advantageous features according to the present invention are described in the dependent claims.

The invention will now be better illustrated with the aid of the accompanying drawings of two examples of embodiment (not to be regarded as limiting), in which:

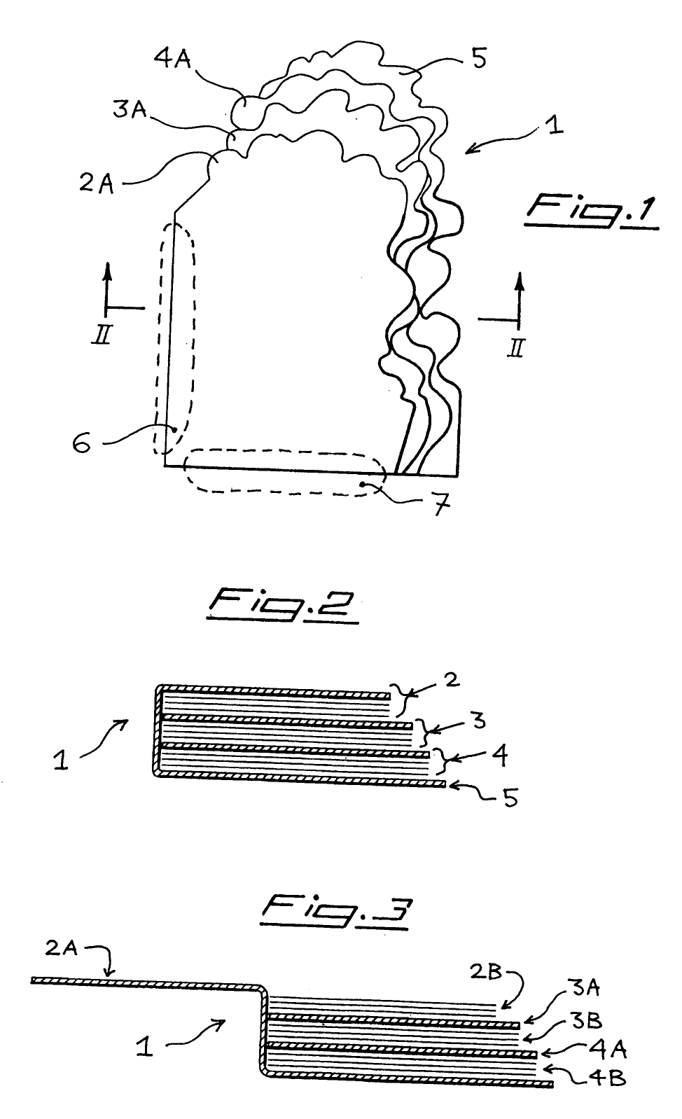

FIG. 1 shows the front view of a book according to the present invention;

FIG. 2 shows the cross-sectional view along plane II-II of the book according to FIG. 1 in the closed position;

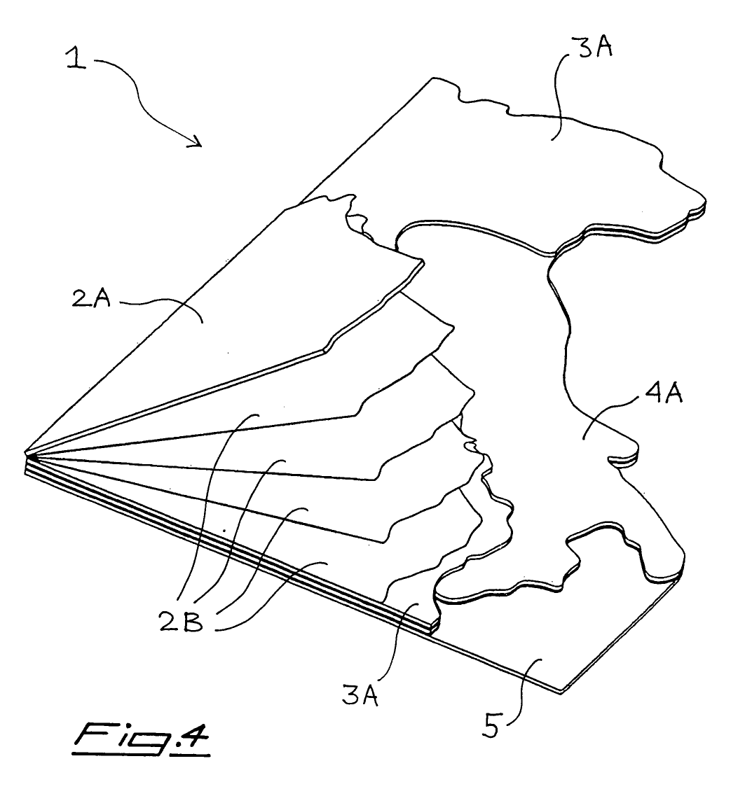

FIG. 3 shows the cross-sectional view along plane II-II of the book according to FIG. 1 in the open position;

FIG. 4 shows the axonometric view of another book according to the present invention.

With reference to the figures, an article in the form of a book, according to the present invention, comprises a plurality of pages which are bound together and divided into different sections adjacent to each other; the two examples of embodiment shown in the figures are actual books and are indicated by the reference number 1; in both these examples the books have three sections which are indicated respectively by the reference numbers 2,3,4; obviously in other embodiments, there could be a different number of sections (2,3,4,5,6,7,8,9,10, etc.).

The present invention is not limited to a type of binding; among the most common systems for binding books the following may be mentioned: saddle stiches, sewn signatures, spiral binding and paperback binding.

In an article according to the present invention, each of the sections comprises at least one page of a first type and at least one page of a second type (different from the first type), all the pages of each section have the same shape, the pages of different sections have different shapes and, when the book is closed, the combination of the different sections forms a subject in relief.

It is precisely the subject in relief, with its three-dimensional effect, which is a source of attraction both for children and for adults.

In both the examples in the figures, each of the three sections 2,3,4 consists of a first cardboard page, indicated respectively by the reference numbers 2A,3A,4A, and by some following paper pages, indicated respectively in their entirety by the reference numbers 2B,3B,4B; obviously, in other embodiments, the sections could be different from each other in terms of the number and type of component pages; moreover, it is possible to envisage more than two types of pages.

The subject represented in the example according to FIG. 1 is a tree; the subject has its own intrinsic three-dimensionality: it has therefore been “sliced” along parallel planes; each “slice” corresponds to a section.

The subject represented in the example according to FIG. 4 is the country of Italy; the subject has the intrinsic possibility of being divided, in the example, into geographic areas (North, South, Islands); it has therefore been given a three-dimensional form, making use of this intrinsic division.

Very many subjects are suitable for forming an article according to the present invention; they may be single subjects, as in the case of the two examples; alternatively, they may be complex subjects, namely a set of single subjects related to each other, for example, spatially or temporally: a nativity scene with its characters, a farm with its animals, a car with its components, the set formed by egg/chick/chicken, etc.; in the case of complex subjects, the division into sections could, for example, correspond to different single subjects. The article according to the present invention may be a true book (to be watched and/or read) or, for example, an active book, a colouring book, etc.

The contents (text, images, etc.) of the article according to the present invention will be typically and advantageously related to the subject in relief.

The basic idea underlying the present invention may be advantageously used in books intended both for children at a schooling age and those at a pre schooling age.

Applications of this idea are, however, possible also in books for adults which may be of a more or less serious nature; an original application could consist, for example, in a fast-food menu having the three-dimensional form of a hamburger.

The differentiation between the pages in a section could be effected on the basis of the material; in this case, each of the sections comprises at least one page made of a first material and at least one page made of a second material. The present invention is generally not limited by the type of material; among the most common materials for books it is possible to mention, by way of example: paper, cardboard, wood, plastic; a particular material used sometimes for books is EVA (ethylene vinyl acetate).

Alternatively, the differentiation between the pages in a section could be effected on the basis of the thickness; in this case, each of the sections comprises at least one page having a first thickness and at least one page having a second thickness.

Finally, the differentiation between the pages in a section could be effected on the basis of both the material and the thickness; in this case, each of the sections comprises at least one page made of a first material and having a first thickness and at least one page made of a second material and having a second thickness.

It could also be possible to differentiate between the pages in a section on the basis of other factors and characteristics; for example, the differentiation could consist in a different function: pages adapted to contain only images and pages adapted to contain only text.

There are many possible choices for the section structure: number of pages, types of pages, binding order, etc.

If the first and/or the last page in each section is of a first type and one or more pages in each section is/are of a second type, the pages of the first type also act as dividers between the adjacent sections.

According to a preferred embodiment of the present invention, the first and/or last page of each section is made of cardboard and one or more pages of each section is/are made of paper; this arrangement is suitable, in particular, for books with a dual sphere of application: young children and older children; for example, the cardboard pages may be intended for young children also because they may be handled more easily, while the paper pages may be intended for older children.

If the article according to the present invention contains pages, for example made of paper, these pages could be unprinted or printed or only partially printed and be adapted to be written on; in this case, the article could be a note pad or a diary; in the case of the diary, the cardboard pages—or in any case the different pages of the sections—could correspond, for example, to the division according to months.

A well-designed article according to the present invention must provide not only a good three-dimensional effect, but also the possibility of resting on its rear side so that it can be read without difficulty.

In order to satisfy this requirement, it is possible to envisage, for example, that the area of a page in a section is smaller than the area of any one page in any one following section; both the examples illustrated are designed in this way.

In order to satisfy better this requirement, it is possible to envisage, for example, that the contour of a page in one section does not protrude substantially beyond the contour of any one page in any one following section; both the examples illustrated are designed in this way; in the example according to FIG. 1, as can be noted, the projections are of a limited amount in a limited number of positions. In some applications, it is advantageous for the article to be able to be rested not only (on its rear side) parallel to the support surface, but also transversely with respect to the support surface; in this way the subject in relief is more easily visible also when the book is not being read.

A way of obtaining this result is that of envisaging that the pages are bound together along a corresponding substantially straight portion of their contour and that the pages are formed so that the book remains in equilibrium on a surface substantially perpendicular to this portion in particular when the book is slightly open; the stability of the equilibrium may depend on various factors including: the number of pages in the book, the material and the thickness of the pages, etc.; in the example according to FIG. 1, this portion is indicated by the reference number 6.

In this case, a simple choice as to the shape of the pages corresponds to the situation where the pages have a corresponding additional portion of their contour which is substantially straight, for transverse support; in the example according to FIG. 1, this additional portion is indicated by the reference number 7.

As regards the cover—an element which all existing books have—it is possible to envisage that the first page of the first section also acts as a front cover page and that, in addition or as an alternative, the last page of the last section also acts as a rear cover page; in the example according to FIG. 1, FIG. 2 and FIG. 3, the first page 2A of the first section 2 also acts as a front cover page, while the rear cover page is an additional page indicated by the reference number 5.

The addition of the graphic element to the three-dimensional effect improves considerably the attractiveness of the article according to the present invention.

In this case it is possible to envisage, for example, that the first page of each section is of a first type and one or more other pages of each section are of a second type and that, on the pages of the first type, symbols and/or figures are reproduced in positions such as to form the immage of the subject when the book is closed.

The choice of the thickness, but in particular of the material of the pages of the first type, may be advantageously performed so as to give maximum emphasis to the symbols and/or the figures shown thereon.

The present invention does not exclude obviously, the insertion in the book, of additional elements such as, for example, a luminous device, an acoustic device, etc.

The present invention does not exclude, moreover, the use of any other measure known in the sector.

1. Book (1) comprising a plurality of pages bound together and divided into different sections (2,3,4) adjacent to each other, characterized in that each of the sections comprises at least one page (2A,3A,4A) of a first type and at least one page (2B,3B,4B) of a second type, in that all the pages of each section have the same shape, in that pages of different sections have different shapes and in that, when the book is closed, the combination of the different sections (2,3,4) forms a subject in relief.

2. Book according to claim 1, in which each of the sections comprises at least one page made of a first material and/or having a first thickness and at least one page made of a second material and/or having a second thickness.

3. Book according to claim 1 or 2, in which the first and/or the last page of each section is of a first type and in which one or more pages of each section is/are of a second type.

4. Book according to claim 3, in which the first and/or the last page of each section is made of cardboard and in which one or more pages of each section is/are made of paper.

5. Book according to any of the preceding claims, in which the area of a page in one section (2) is smaller than the area of any one page in any one following section (3,4).

6. Book according to claim 5, in which the contour of a page in one section (2) does not protrude substantially beyond the contour of any one page in any one following section (3,4).

7. Book according to any of the preceding claims, in which the pages are bound together along a corresponding first substantially straight portion (6) of their contour and in which the pages are formed so that the book remains in equilibrium on a surface substantially perpendicular to said first portion (6) in particular when slightly open.

8. Book according to claim 7, in which the pages have a corresponding second portion (7) of their contour which is substantially straight, for resting them on said surface.

9. Book according to any of the preceding claims, in which the first page of the first section and/or the last page of the last section also acts/act as a cover.

10. Book according to any of the preceding claims, in which the first page of each section is of a first type and in which one or more other pages of each section is/are of a second type and in which, on the pages of the first type, symbols and/or figures are reproduced in positions such as to form the image of said subject when the book is closed.
